(19) United States
(12) Patent Application Publication
(10) Pub. No.: US 2006/0083817 A1
(43) Pub. Date: Apr. 20, 2006

(54) Toggle joint of an injection molding machine

(76) Inventor: Jui-Hsiang Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/963,524

(22) Filed: Oct. 14, 2004

(51) Int. Cl. B29C 45/66

(52) U.S. Cl. 425/593

(57) ABSTRACT

A toggle joint of an injection molding machine includes several spaced stationary arm members, a movable arm member, a pivotal rod, and bushings fitted in the movable arm member; the pivotal rod has oil passages therein, and it is connected to the stationary arm members and passed through the bushings such that the movable arm member pivots on the pivotal rod; each of the bushings has oil passages on an inner side, and two annular grooves on the inner side, which are on two sides of the oil passages; leak-prevention rings are respectively fitted on the annular grooves of the bushings for preventing leakage of lubricating oil when the oil is supplied between the bushings and the pivotal rod from the pivotal rod.

### BACKGROUND OF THE INVENTION

1. Field of the invention

The present invention relates to a toggle joint of an injection molding machine, more particularly one, which is equipped with leak prevention rings between a pivotal rod and bushings of a movable arm member thereof such that lubricating oil is prevented from leaking out.

2. Brief Description of the Prior Art

Injection molding machines are usually equipped with toggle joints, which are connected with both a stationary support disk and a movable mold seat so as to help displace the movable seat when an actuator is functioning.

Referring to FIG. 6, a conventional toggle joint 6 of an injection molding machine includes a stationary support disk, several spaced stationary arm members 61 secured on the stationary support disk, a movable arm member 62, a pivotal rod 63, and bushings 64 fitted in the movable arm member 62. The pivotal rod 63 is connected to the stationary arm members 61 and passed through the bushings 64 such that the movable arm member 62 pivots on the pivotal rod 63. In addition, the pivotal rod 63 has several oil passages 631 therein, through which lubricating oil can be supplied between outer side of the pivotal rod 63 and the bushings 64.

When an actuator functions to cause linear displacement of a movable mold seat (not shown) of the molding machine relative to a stationary mold seat (not shown), the movable arm member 62 will be angularly displaced. However, oil leakage from the toggle joint will happen after the molding machine is used for a certain period of time.

### SUMMARY OF THE INVENTION

It is a main object of the present invention to provide an improvement on a toggle joint of an injection molding machine to overcome the above disadvantage.

The toggle joint of the present invention includes a stationary support disk, several spaced stationary arm members secured on the stationary support disk, a movable arm member, a pivotal rod, and bushings fitted in the movable arm member. Each of the bushings has oil passages on an inner side. The pivotal rod is connected to the stationary arm members and passed through the bushings such that the movable arm member pivots on the pivotal rod. Furthermore, each of the bushings has two annular grooves on the inner side, which are on two sides of the corresponding oil passages. And, leak-prevention rings are respectively fitted on the annular grooves of the bushings such that lubricating oil between the bushings and the pivotal rod is prevented from leaking out.

### BRIEF DESCRIPTION OF THE DRAWINGS

The present invention will be better understood by referring to the accompanying drawings, wherein:

FIG. 1 is a top view of the toggle joint of an injection molding machine according to the present invention,

FIG. 2 is a side view of the toggle joint of the present invention,

FIG. 3 is a partial exploded perspective view of the toggle joint of the present invention,

FIG. 4 is a partial cross-sectional view of the present toggle joint of the present invention,

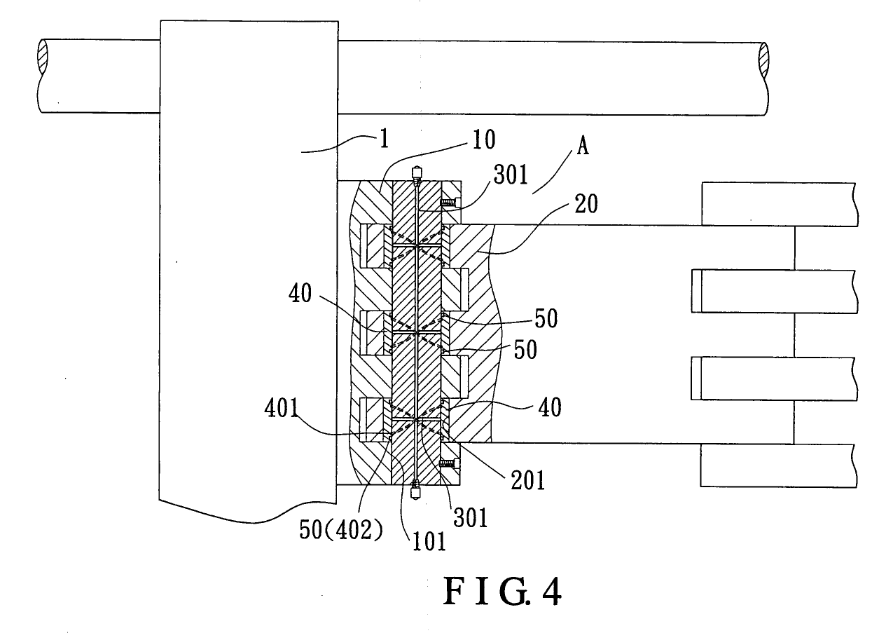

FIG. 5 is an enlarged partial cross-sectional view of the toggle joint of the present invention, and

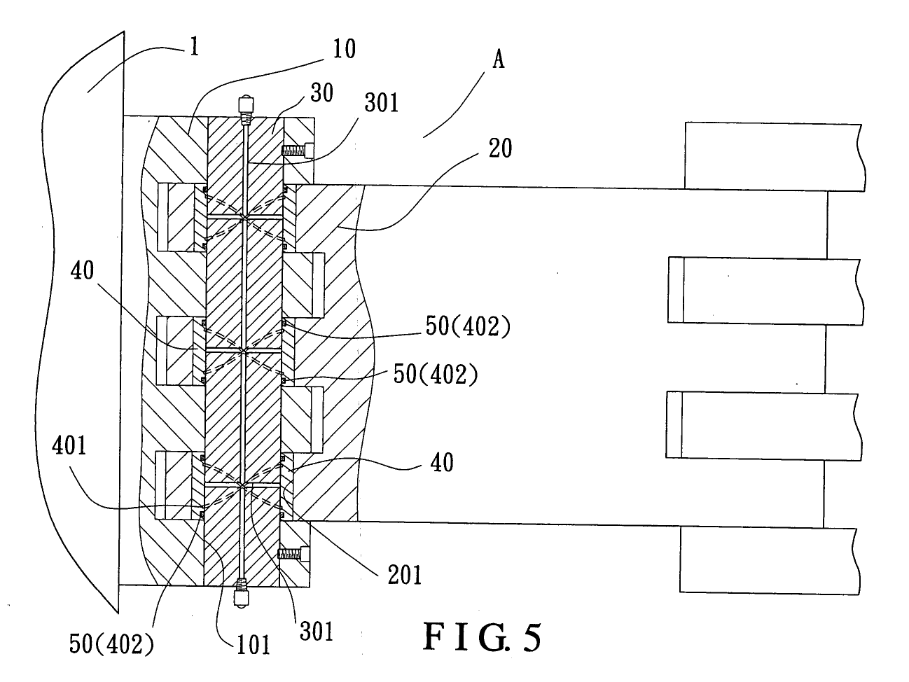

FIG. 6 is a partial section of the conventional toggle joint.

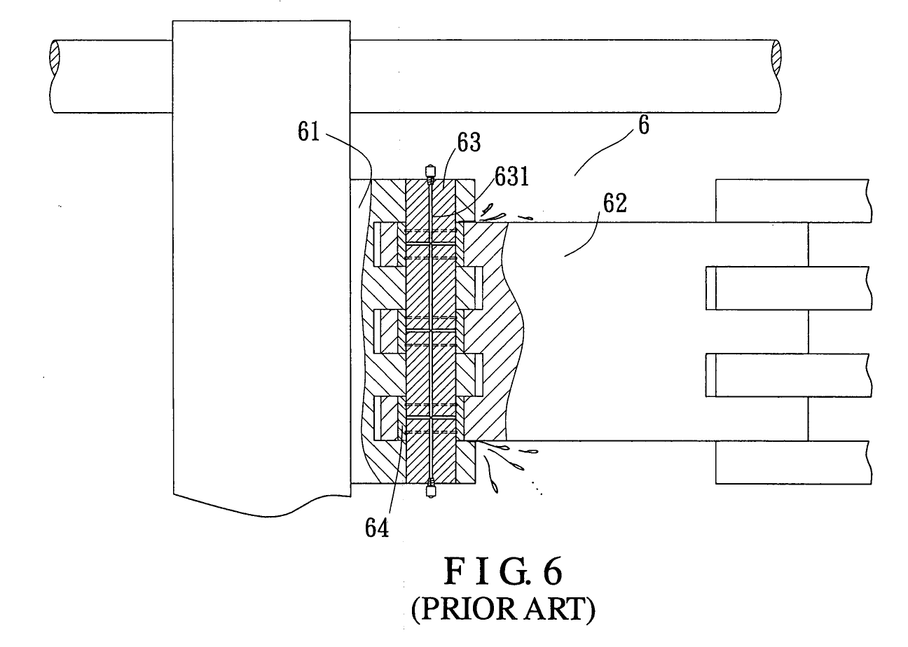

### DETAILED DESCRIPTION OF THE PREFERRED EMBODIMENTS

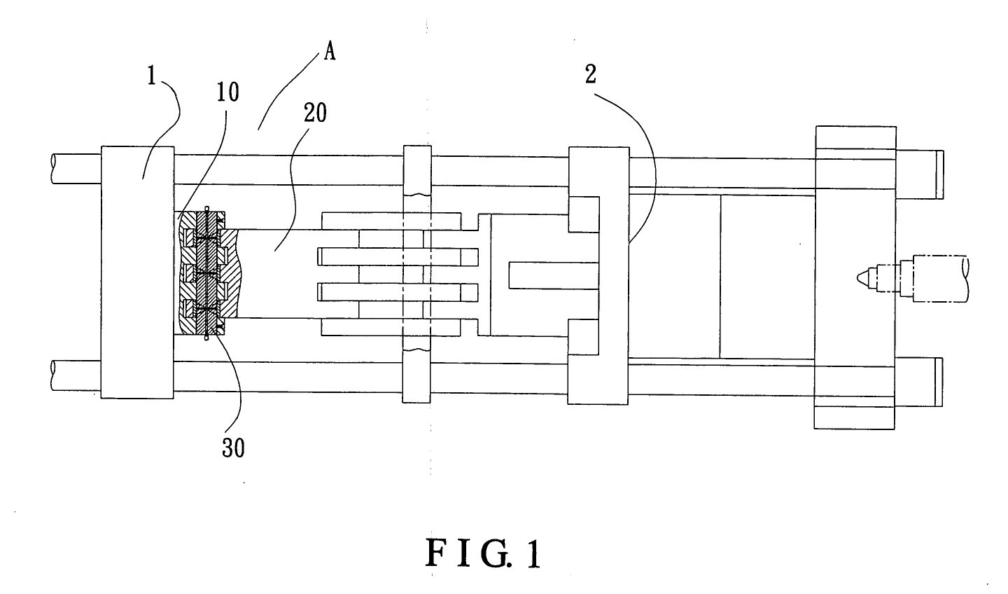

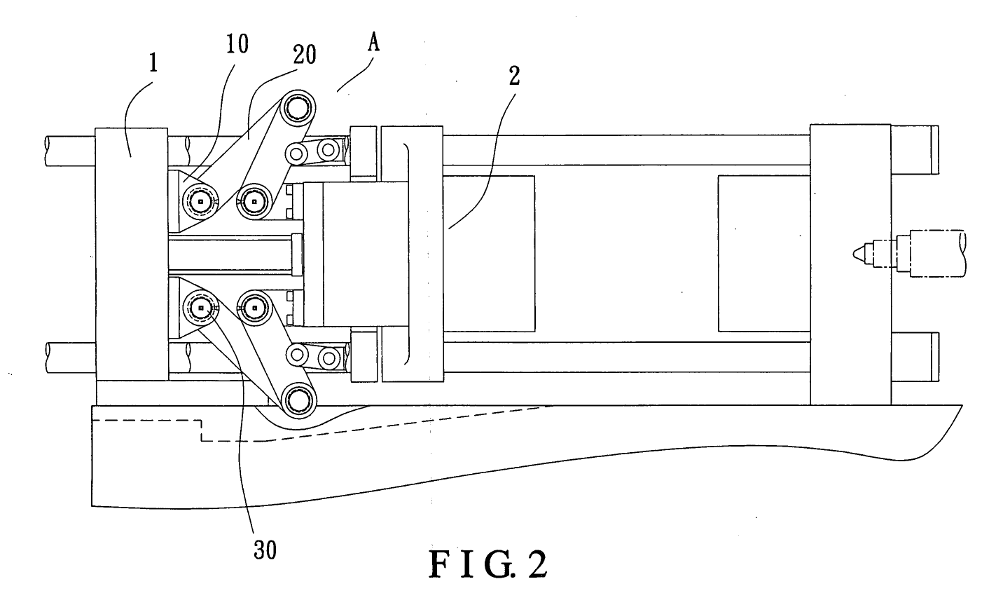

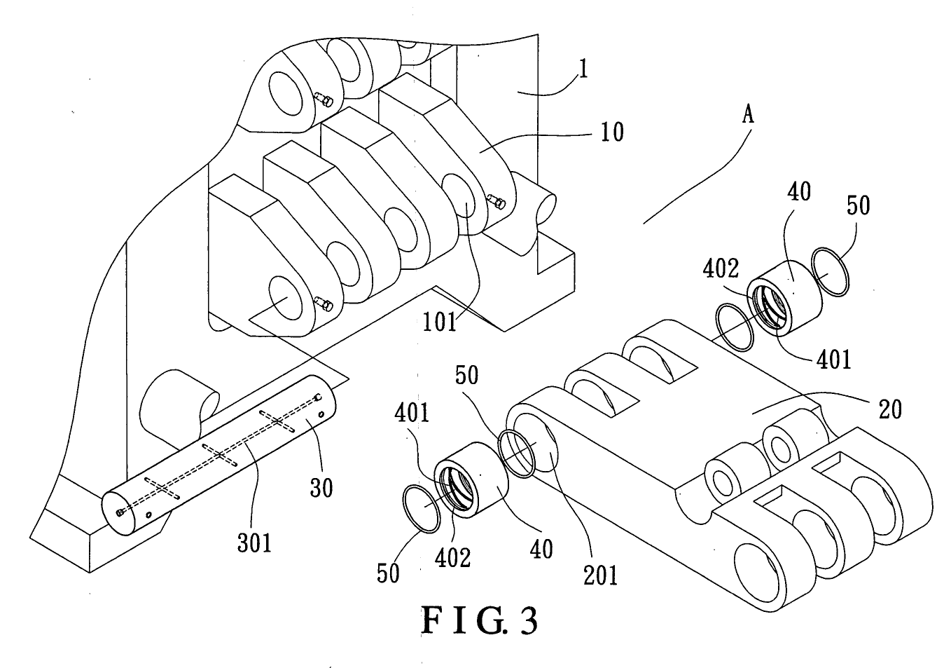

Referring to FIGS. 1 to 3, a preferred embodiment (A) of a toggle joint of an injection molding machine includes a stationary support disk 1, stationary arm members 10, a first movable arm member 20, a pivotal rod 30, bushings 40, and leak-prevention rings 50.

The stationary support disk 1 is disposed on one end of a bed of the molding machine.

The stationary arm members 10 are spaced apart on the stationary support disk 1, and they are formed with aligned pivotal holes 101.

The first movable arm member 20 has several pivotal holes 201 at a first end, which are spaced apart and aligned with each other.

Each of the bushings 40 has two annular grooves 402 on an inner side, and oil passages 401 between the annular grooves 402 on the inner side. The bushings 40 are fitted in respective ones of the pivotal holes 201 of the first movable arm member 20.

The leak-prevention rings 50 are fitted on respective ones of the annular grooves 402 of the bushings 40.

The pivotal rod 30 has oil passages 301 therein, and it is passed through the pivotal holes 101 of the stationary arm members 10, and the bushings 40 in the first movable arm member 20. And, the pivotal rod 30 is connected to the stationary arm members 10 such that it can't be angularly displaced. Thus, the first movable arm member 20 and other movable arm members (not numbered) of the toggle joint will be angularly displaced when an actuator is functioning to cause linear displacement of a movable mold seat 2 of the molding machine relative to a stationary mold seat (not numbered). And, lubricating oil can be supplied between the bushings 40 and the pivotal rod 30 via the oil passages 301 in the pivotal rods 30 and the oil passages 401 on the inner sides of the bushings 40. Furthermore, the leak-prevention rings 50 will be closely fitted around the pivotal rod 30, preventing lubricating oil from leaking out of the toggle joint.

The leak-prevention rings 50, which are fitted on the annular grooves 402 of the bushings 40, can prevent lubricating oil from leaking out of the toggle joint of the present invention, overcoming the problem with leakage that exists in conventional toggle joints without proper leak-prevention means.

What is claimed is:

1. A toggle joint of an injection molding machine, comprising
a stationary support disk disposed on one end of a bed of a molding machine;
a plurality of stationary arm members spaced apart on the stationary support disk; the stationary arm members having pivotal holes aligned with each other;
a first movable arm member having a plurality of pivotal holes at one end, which are spaced apart and aligned with each other;
a plurality of bushings fitted in respective ones of the pivotal holes of the first movable arm member; each of the bushings having a plurality of oil passages on an inner side thereof; and
a pivotal rod passed through the pivotal holes of the stationary arm members, and the bushings in the first movable arm member for the first movable arm member to pivot on the stationary arm members;
each of the bushings having two annular grooves on the inner side, which are on two sides of corresponding oil passages; the bushings having leak-prevention rings respectively fitted on the annular grooves thereof for preventing leakage of lubricating oil contained between the bushings and the pivotal rod.
